(19) United States
(12) Patent Application Publication
(10) Pub. No.: US 2007/0226901 A1
(43) Pub. Date: Oct. 4, 2007

(54) Bed Lift Mechanism For A Vehicle

(75) Inventors: John Pervorse, Corona, CA (US); Tibor Olah, Covina, CA (US)

Correspondence Address: INSKEEP INTELLECTUAL PROPERTY GROUP, INC, 2281 W. 190TH STREET, SUITE 200, TORRANCE, CA, 90504, US

(73) Assignee: RBW Industries, Inc.

(21) Appl. No.: 11/669,065

(22) Filed: Jan. 30, 2007

Related U.S. Application Data
(60) Provisional application No. 60/763,329, filed on Jan. 30, 2006.

(51) Int. Cl. B60P 3/38

(52) U.S. Cl. 5/118; 5/11

(57) ABSTRACT

In one preferred embodiment the present invention provides a motorized lift system having a winch that winds or unwinds four straps to increase or decrease the height of a bed. To maintain the horizontal position of the bed and prevent swinging, the bed frame includes four rollers that each engage a channel of a vertical rail. In this respect, the lift modifies the bed's elevation while maintaining a desired horizontal position.

### RELATED APPLICATIONS

This application claims priority to U.S. Provisional Application Ser. No. 60/763,329 filed Jan. 30, 2006 entitled Bed Lift Mechanism For A Vehicle and is hereby incorporated by reference.

### BACKGROUND OF THE INVENTION

In recreational vehicles, boats and trailers (collectively, “RV's”), there is an ever present need for lifting mechanisms. While such lifting devices are rarely a necessity in RV's, they nevertheless maintain an important functional role with respect to space maximization and storage.

Generally, RV's are constrained in size by their safety to drive, ease to maneuver, and affordability to the average traveler. Further, RV manufacturing companies have strived to provide the greatest number of features in the least amount of space. Consequently, improvements have been made over the years to increase the amount of usable space within the vehicle.

Some designs attempt to maximize space by way of lifting devices. Thus, to the extent feasible, the used space can be convertible for dual or even multiple purposes by lifting furniture or other objects out of the way.

One of the largest pieces of furniture within an RV is the bed. Many designers have maximized usable space by designing a bed that lowers and raises within an RV. Examples of such designs include U.S. Publication No. 20050001444 and U.S. Pat. Nos. 6,557,190; 6,231,114; and 3,266,062, all herein incorporated by reference.

Some bed lift designs, such as the design of U.S. Pat. No. 5,984,404, the contents of which are herein incorporated by reference, use straps and pulleys to increase or decrease the height of the bed. Lift systems such as these that use retractable straps are often desirable due to their overall low weight, inexpensive components, and lifting efficiency.

While these strap designs operate with general satisfaction, their strap supports typically allow the bed to move and swing horizontally when the vehicle is in motion or when in use by the user. In some circumstances, this horizontal movement may cause the bed to contact portions of the vehicle's interior, possibly resulting in damage. Further, the straps used to support the bed are typically fully exposed to the vehicle's interior, allowing for possible snags or damage, as well as undesirable aesthetics.

What is needed is a lift system that includes the light weight and inexpensive costs of a strap lift, while reducing horizontal movement and wear on the straps.

### OBJECTS AND SUMMARY OF THE INVENTION

It is an object of the present invention to overcome the limitations of the prior art.

It is another object of the present invention to provide an improved bed lift utilizing straps and pulleys.

It is yet another object of the present invention to provide a lift system that prevents damage to the vehicle from horizontal movement of the suspended bed.

It is another object of the present invention to provide a lift system that reduces the visibility of the lifting straps.

It is another object of the present invention to provide a lift system that reduces the wear and damage to the lifting straps.

In one preferred embodiment, the present invention attempts to achieve these objects by providing a motorized lift system having a winch that winds or unwinds four straps fixed near the vehicle's ceiling to increase or decrease the height of a bed or other furniture. To maintain the horizontal position of the bed and prevent swinging, the bed frame includes four rollers that each engage a channel of an adjacent vertical rail. In this respect, the lift modifies the bed's elevation while maintaining a desired horizontal position.

### BRIEF DESCRIPTION OF THE DRAWINGS

FIG. 1 illustrates a perspective view of a lift system according to the present invention;

FIG. 2 illustrates a side profile view of the lift system of FIG. 1;

FIG. 3 illustrates an end profile view of the lift system of FIG. 1;

FIG. 4 illustrates an enlarged view of area 4 of FIG. 3;

FIG. 5 illustrates an enlarged view of area 5 in FIG. 2;

FIG. 6 illustrates an enlarged view of area 6 in FIG. 3;

FIG. 7 illustrates a perspective view of a lift system according to the present invention;

FIG. 8 illustrates a perspective view of the lift system of FIG. 7;

FIG. 9 illustrates a perspective view of the lift system of FIG. 7;

FIG. 10 illustrates a perspective view of a rail according to the present invention;

FIG. 11 illustrates a perspective view of a stop according to the present invention;

FIG. 12 illustrates a perspective view of a stop according to the present invention;

FIG. 13 illustrates a perspective view of a manual lift system according to the present invention;

FIG. 14 illustrates an end view of the manual lift system of FIG. 13;

FIG. 15 illustrates a side view of the manual lift system of FIG. 13; and

FIG. 16 illustrates a perspective view of a lift system according to the present invention.

### DETAILED DESCRIPTION OF THE INVENTION

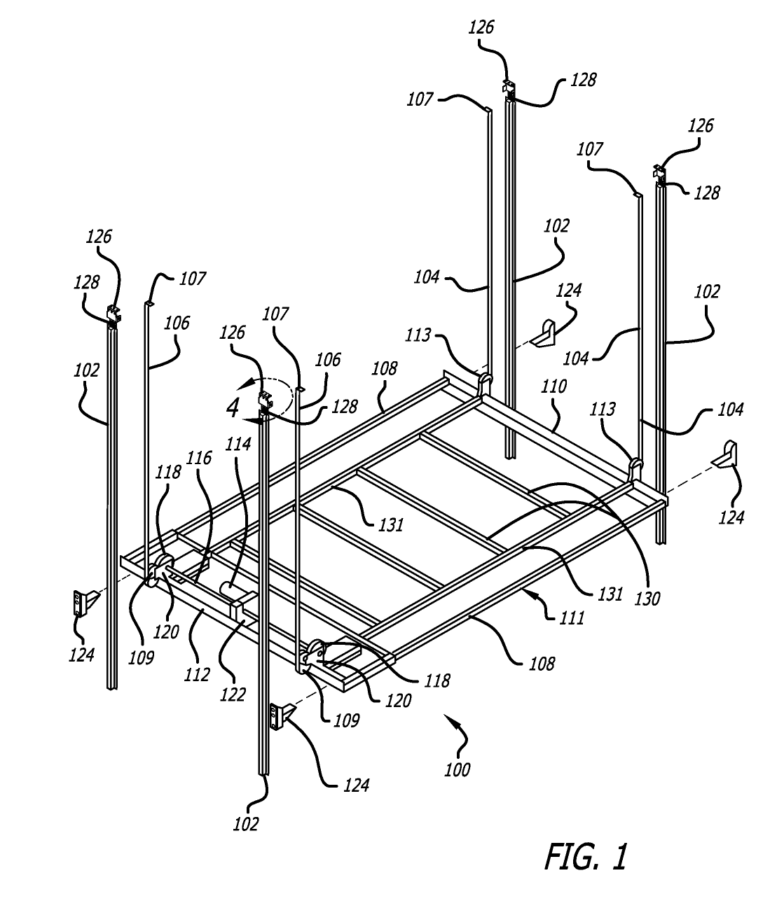

FIGS. 1-6 illustrate a preferred embodiment of a lift system 100 according to the present invention. Generally speaking, the lift system 100 can adjust a height of a frame 111 on which a mattress or other furniture can be placed while maintaining the latitudinal or horizontal position of the frame 111. In this respect, the lift system 100 reduces damage caused by the frame 111 to adjacent portions of the vehicle due to vehicle movement or use by the user.

More specifically, the lift system 100 includes two preferred positioning systems: a motorized pulley system to achieve a desired elevation of frame 111 and a plurality of vertical rails 102 which maintain the horizontal position of the frame 111. Both of these systems are described in more detail below.

The motorized pulley system utilizes a motor 114 to extend and retract two proximal straps 106 and two distal straps 104 via winch wheels 118, seen best in FIG. 1, forming a winch. Preferably, the straps 104 and 106 are composed of a strong but flexible material such as nylon. Each winch wheel 118 connects to an end of one proximal strap 106 and an end of one distal strap 104, allowing the winch wheel 118 to extend or retract both straps 104 and 106 simultaneously by rotating in one direction or another. In other words, the straps 104 and 106 are wound on top of each other, allowing each winch wheel 118 to simultaneously wind and unwind both straps 104 and 106.

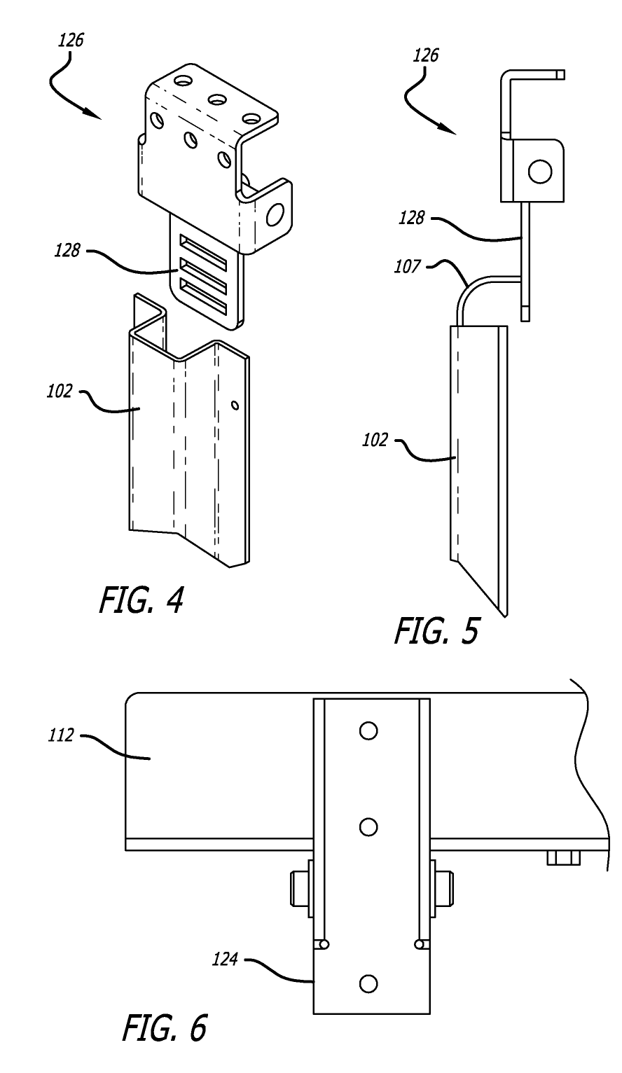

The opposite ends of the straps 104 and 106 (i.e. the ends not connected to and wound on the winch wheel 118) include mounting hooks 107, as seen best in FIG. 5, which are sized to engage slots 128 of support bracket 126, as best seen in FIG. 4. The support bracket 126 is preferably located above each vertical rail 102, mounted to a wall of the vehicle with screws, so that the slots 128 are immediately above or even within the channel of each rail 102, allowing the straps 104 or 106 to lay within the curved channel of the rail 102 (i.e. within the thickness of the rail 102 as seen in FIG. 5 or directly below the slots 128 in FIG. 4). Thus, each support bracket 126 ultimately supports a portion of the weight of the frame 111.

As seen in FIG. 1, the proximal straps 106 have the shortest path to the winch wheel 118, pressing against and underneath a proximal strap roller 109 before passing around the winch wheel 118. Thus, as the winch wheel 118 rotates, the strap 106 moves against strap roller 109, causing rotation of the strap roller 109.

The distal strap 104 has a somewhat longer path from the mounting hook 107 to the winch wheel 118, pressing against and underneath a distal strap roller 113, and then passing through a hollow frame member 131 to the winch wheel 118. Each hollow frame member 131 is aligned near the distal strap roller 113 and the winch wheel 118 to create a relatively straight path. Additionally, the hollow frame member 131 provides protection to the distal straps 104 from snags, tears and other damage that otherwise may occur if it was exposed beneath the frame 111.

The distal strap rollers 113 are mounted to a distal frame member 110 while the proximal strap rollers 109 are mounted to a winch bracket 120 on the proximal frame platform 112. The winch wheels 118, on which the straps 104 and 106 are simultaneously rolled or unrolled, are also mounted within the winch bracket 120.

Each of the winch wheels 118 are coupled to a drive shaft 116, which passes through motor mounting bracket 122. The motor 114 is fixed to the motor mounting bracket 122 and is coupled via unseen gearing to the drive shaft 116. In this respect, the motor 114 rotates the drive shaft 116 and therefore the winch wheels 118, retracting or extending the straps 104 and 106 and ultimately causing the frame 111 to raise or lower.

In the preferred embodiment shown in FIGS. 1-6, the frame 111 includes side frame members 108, distal frame member 110, proximal frame platform 112, hollow frame members 131, and lateral frame members 130. However, additional frame designs are possible. For example, the frame member may be a single hollow platform with apertures that allow the distal straps 104 to pass through at positions similar to those shown in the preferred embodiment of FIGS. 1-6.

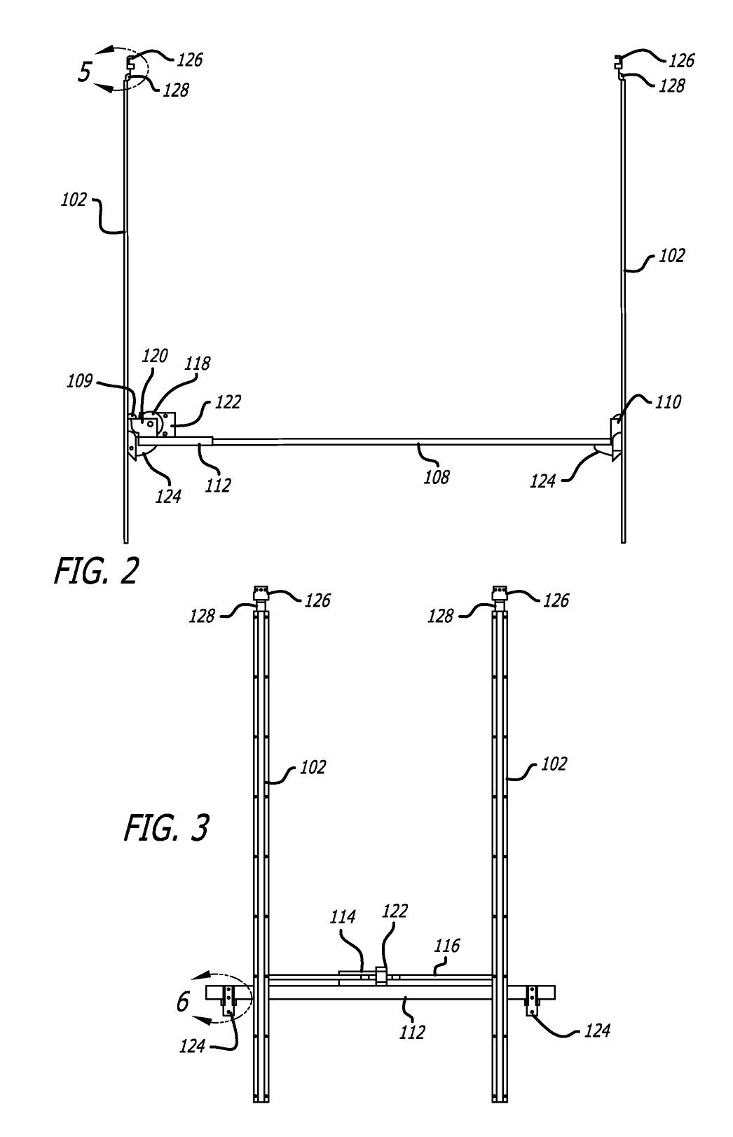

As previously mentioned, the lift system 100 includes four vertical rails 102 which prevent horizontal movement of the frame 111. Specifically, as seen in FIGS. 4 and 5, the rails 102 have a “C” cross section shape which forms a channel along the length of the rails 102 and are preferably mounted within a wall of the vehicle so that this channel is exposed. Each rail 102 is positioned adjacent to the frame 111, as seen in FIGS. 2 and 3, so that each roller 109 and 113 rolls within this channel as the frame 111 is moved up or down. In this respect, if the frame 111 encounters force that would otherwise cause horizontal movement, the rollers 109 and 113 move against the walls of the channel of rail 102, maintaining the horizontal position of the frame 111 and therefore preventing the frame 111 from swinging into and otherwise damaging adjacent interior portions of the vehicle.

Since the hooks 107 of the straps 104 and 106 are supported above the rails 102 as best seen in the partially exploded view of FIG. 1, a portion of the straps 104 and 106 maintain a position substantially within the channel of the rail 102, protecting the straps 104 and 106 from snags, wear and other damage. Additionally, this arrangement at least partially conceals the straps, improving the aesthetics of the vehicle's interior.

Preferably, the rails 102 are imbedded within a wall of the vehicle, exposing the channels and reducing the visibility of the rails 102. Alternately, in another preferred embodiment, the walls themselves may include vertical channels. In another preferred embodiment, the rails 102 are mounted freely in the vehicle.

Preferably, as best seen in FIGS. 1, 2, 3, and 6, the lift system 100 includes stops 124 mounted to the interior walls of the vehicle. These stops 124 are positioned to contact a lower surface of the frame 111 at a predetermined level, providing additional vertical support to the frame 111 and a lower limit, beyond which the frame 111 cannot be lowered.

Optionally, these stops 124 can be folded out of the way of the frame 111 so as to prevent contact and allow the frame 111 to be lowered even further. Alternatively, the stops 124 may include a removable mounting system that allows the stops 124 to be removed and remounted at various positions. For example, this may be accomplished by including a hook on the stop 124 and multiple apertures at various elevations on the vehicle wall.

Preferably, the frame 111 is sized to support a mattress for a bed. Alternatively, the frame 111 may include a folding back support and cushions to form a couch, bench, or chair. Additionally, the frame 111 may include a solid platform over its top to create a table or storage shelf.

In the preferred embodiment of FIGS. 1-6, the strap rollers 109 and 113 serve the dual purpose of rotating against the straps 104 and 106 and rotating against the channel of the rails 102. However, it should be understood that two rollers could be used, allowing one roller to roll against the channel of the rail 102 and another roller to roll with the movement of the straps 104 or 106. In another preferred embodiment, the present invention may alternately include slides that engage the channel of rails 102 instead of rollers 109 and 113.

In operation, the user lowers the frame 111 by activating the motor 114. The motor 114 rotates gearing within the motor mounting bracket 122, which then rotates the drive shaft 116 and the connected winch wheels 118. As each of the two winch wheels 118 rotate, they each unwind the proximal strap 106 and the distal strap 104 coupled to and wound around the circumference of the winch wheel 118. Thus, the effective or operative lengths of each of the straps 104 and 106 increases, lowering the frame 111 downward.

As the frame 111 moves downward, the proximal strap rollers 109 and the distal strap rollers 113 roll within a channel of the rail 102, facilitating smooth vertical travel and preventing substantial horizontal movement. The frame 111 continues to lower until it contacts the stops 124, at which time the motor 114 and therefore the movement of the frame 111 is stopped. While in a lowered position, the stops 124 provide additional support to the frame 111 and any load the frame 111 may be carrying.

When the user wishes to raise the frame 111, the motor is again activated and caused to rotate in an opposite direction to that previously described. Thus, the drive shaft 116 and winch wheels 118 also rotate in an opposite direction, winding both the proximal strap 106 and the distal strap 104 around the outer circumference of the winch wheels 118. As the winch wheels 118 wind up the straps 104 and 106, the straps 104 and 106 effectively shorten, creating an upwards force that raises the frame 111. As indicated above, the strap rollers 109 and 113 continue to move within the channel of rails 102, allowing the frame 111 to maintain its horizontal position. Once a desired height has been achieved by the frame 111, the motor 114 is turned off.

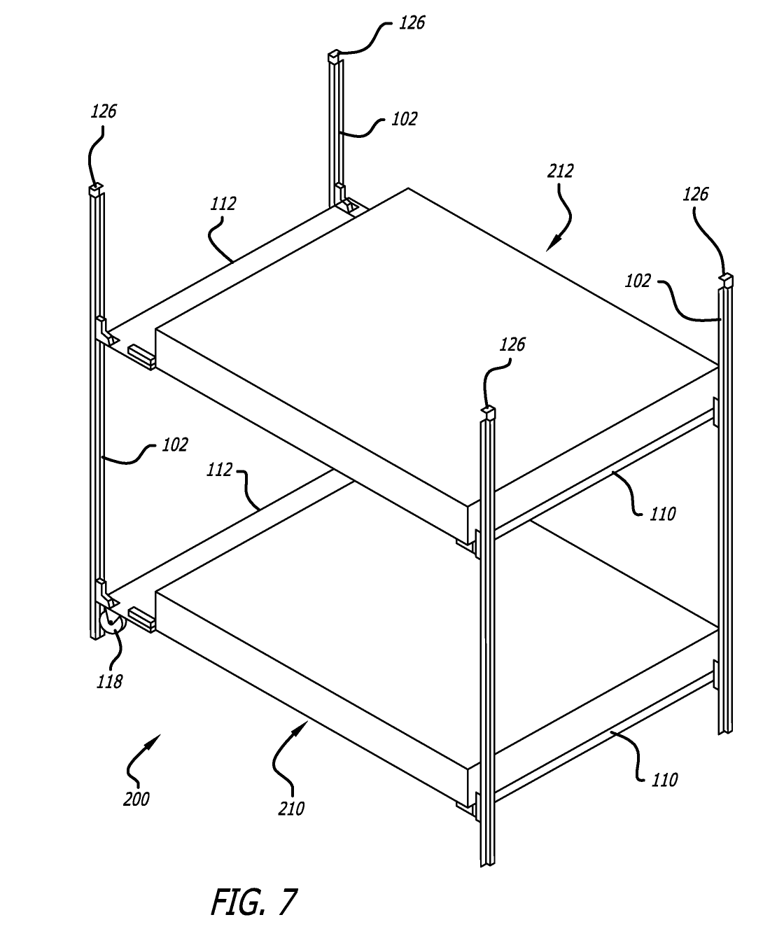

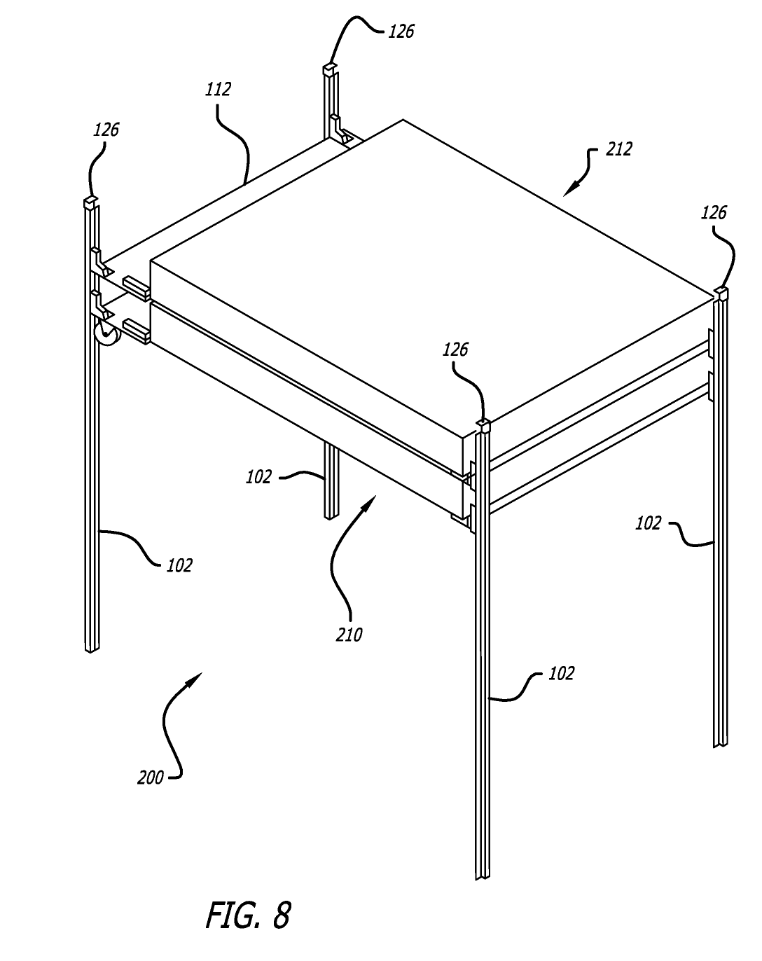

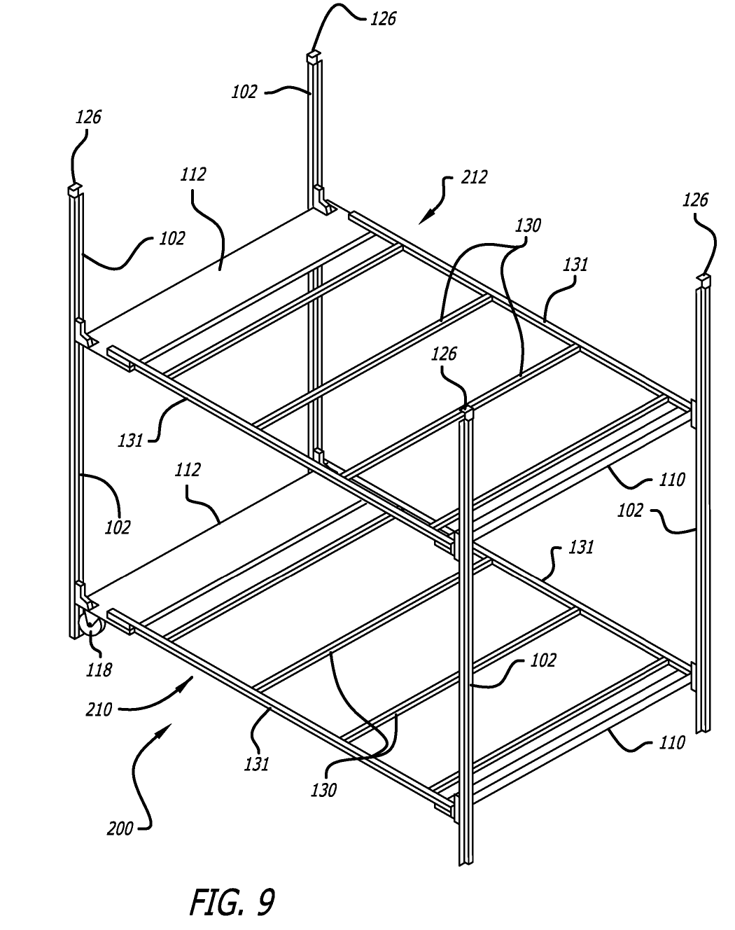

FIGS. 7-9 illustrate another preferred embodiment according to the present invention which is generally similar to the previously described preferred embodiment. However, the lift system 200 includes both an upper bed frame 212 and a lower bed frame 210 that can be lowered, as seen in FIGS. 7 and 9 and raised in FIG. 8.

As seen in these Figures, the motor 114, winch wheels 118 and other previously described lifting mechanisms are alternatively positioned on the underside of the frame platform 112. While both the upper bed frame 212 and the lower bed frame 210 can include these lifting mechanisms, it is possible to include only one lifting mechanism on the lower bed frame 212, which presses against, and therefore lifts the upper bed frame 212 when raised.

As seen in FIG. 11, the rail 102 can include a stop 204 within the channel to prevent the upper bed frame 212 from lowering below a predetermined height. FIG. 12 illustrates alternative stops 206 positioned outside of the channel.

While the preferred embodiments described in this specification have referred to the use of multiple “straps” 104 and 106, it should be understood that other elongated, flexible members can also be preferably used according to the present invention. For example, chains, ropes, or cords can also be used in place of the straps. Further, another preferred embodiment may include combinations of these different types of elongated flexible members, such as straps and chains.

Additional modifications to the preferred embodiments described in this specification can be made by including elements described in the currently pending U.S. application Ser. No. 10/726,352, the contents of which are incorporated herein by reference.

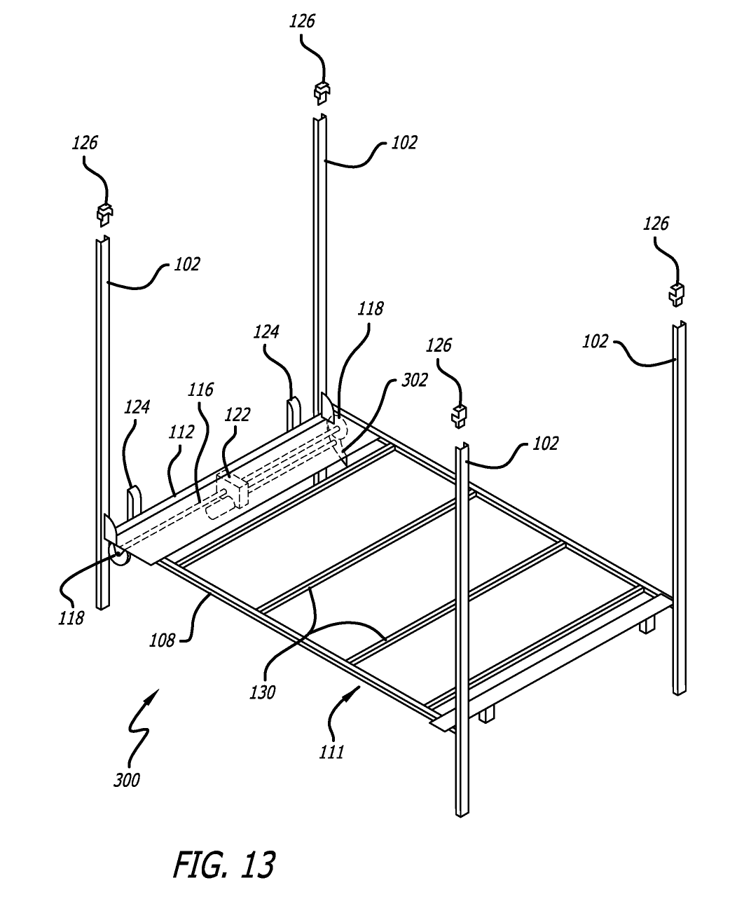

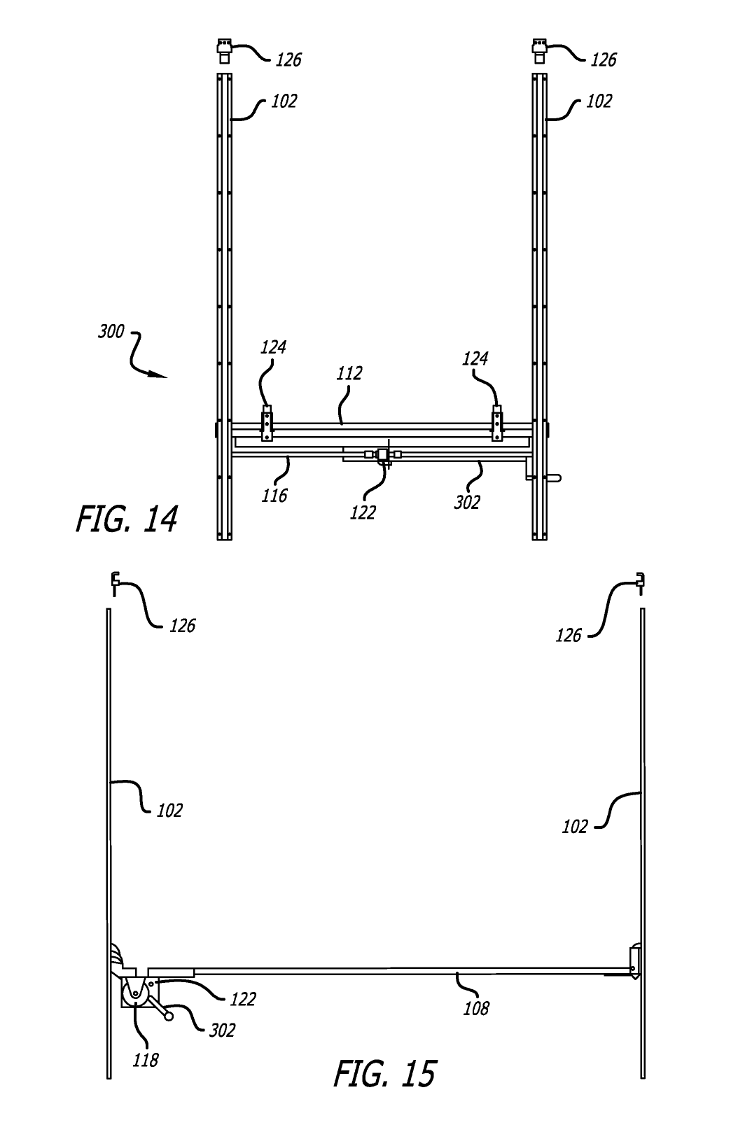

Additionally, while one of the preferred embodiments described in this specification included a motor 114 for raising and lowering the frame 111, it should be understood that a manual force-generating arrangement can also be used, such as a hand crank. For example, FIGS. 13-15 illustrate a manually-actuated lift system 300 according to the present invention which is generally similar to the previously described bed lift system 100. However, the drive shaft 116, winch wheels 118 and mounting bracket 122 are positioned on the underside of the proximal frame platform 112, allowing space for the user to rotate a crank handle 302. The crank handle 302 is connected via gearing on the mounting bracket 122 to the drive shaft 116 in a similar arrangement as motor 114 with the bed lift system 100. In this respect, the user simply rotates the crack handle 302 to change the height of the bed frame 111.

Optionally, the lift system 300 can also include a motor connected to the drive shaft 116, allowing the user the option of changing the height of the bed frame 111 manually or automatically. This option may be especially useful in case of motor failure.

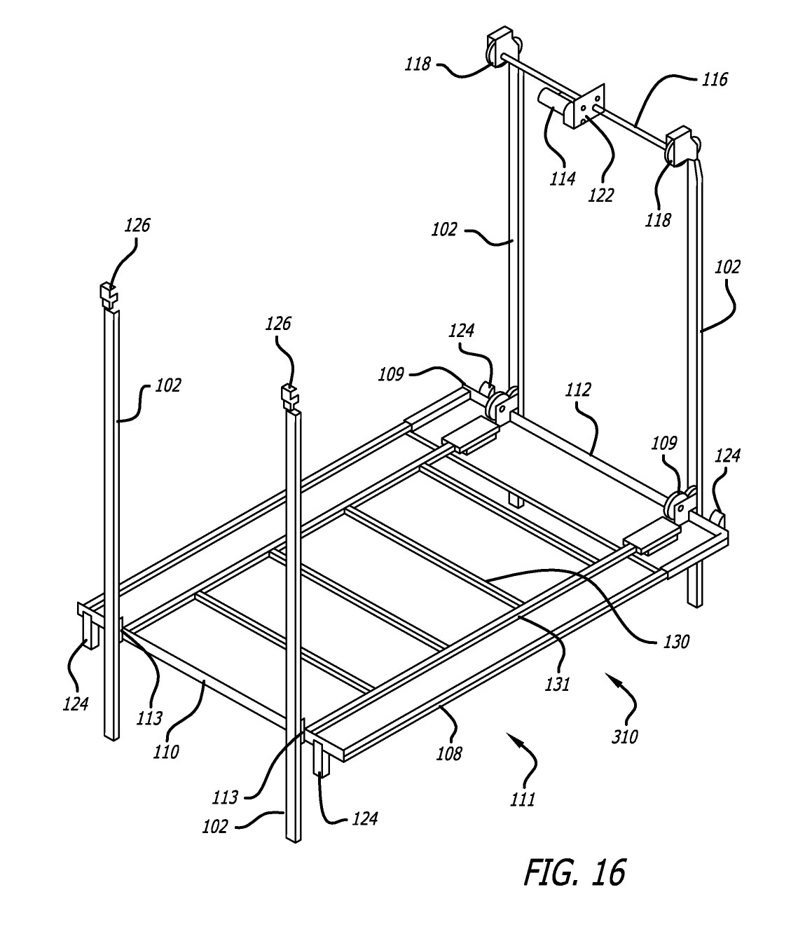

While the motor 114 or crank handle 302 is preferably located on the bed frame 111, the motor 114 may also be located on a nearby wall of the vehicle, as seen in the lift system 310 of FIG. 16. More specifically, the winch wheels 118, drive shaft 116, mounting bracket 122, and motor 114 can be mounted on a wall of the vehicle, near a top area of the vertical rails 102.

Instead of winding two straps 104 and 106 on each side, the winch wheels 118 only wind a single, longer strap (not shown in FIG. 16) that passes down through the channel of the rail 102, against roller 109, through the hollow frame member 131, against roller 113, up the channel of the 102 and finally terminating with the support bracket 126. Thus, as the winch wheels 118 wind the strap, the bed frame 111 increases in height.

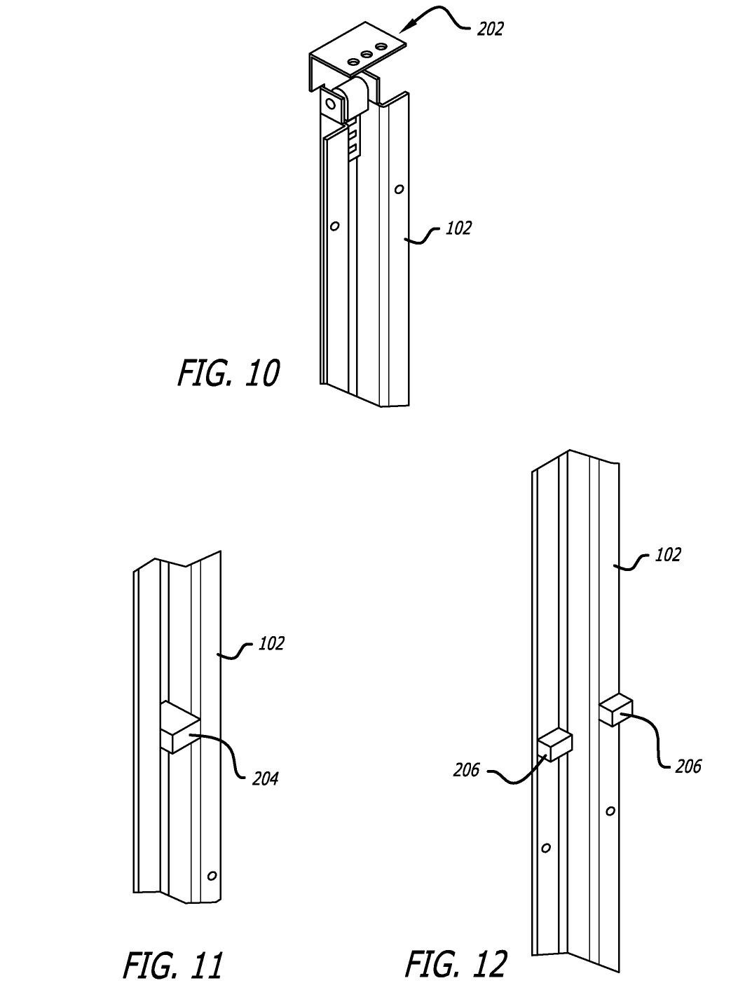

Further, while the preferred embodiments described in this specification have been described in terms of separate, distinct elements, it should be understood that some of these elements can be combine into a single element without departing from the invention. For example, the support bracket 126 and the rail 102 can be a single, connected, unitary element 202, as seen in FIG. 10.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A lifting device within a vehicle comprising:
a frame;
a wheel rotatably disposed on said frame;
a first elongated flexible member having a first end coupled to said wheel and a second end coupled to a location on said vehicle above said frame;
a second elongated flexible member having a first end coupled to said wheel and a second end coupled to a location on said vehicle above said frame, said second elongated flexible member positioned through at least a portion of said frame;
a motor disposed on said frame and coupled to said wheel so as to cause rotation of said wheel;
a first rail fixed vertically adjacent to said frame;
a second rail fixed vertically adjacent to said frame;
a first roller disposed on said frame and positioned to roll against said first rail; and
a second roller disposed on said frame and positioned to roll against said second rail;
wherein said first and second roller are disposed in said first and second rail, respectively, so as to substantially constrain horizontal movement of said frame.

2. The lifting device of claim 1, further comprising:
a third rail fixed vertically adjacent to said frame;
a fourth rail fixed vertically adjacent to said frame;
a third roller disposed on said frame and positioned to roll against said third rail; and
a fourth roller disposed on said frame and positioned to roll against said fourth rail;
wherein said third roller and said third rail and said fourth roller and said fourth rail are configured to maintain a horizontal position of said frame.

3. The lifting device of claim 1, wherein said first elongated flexible member is positioned to contact said first roller and said second elongated flexible member is positioned to contact said second roller.

4. The lifting device of claim 1, wherein said second end of said first elongated flexible member is coupled above said first rail.

5. The lifting device of claim 1, wherein said first elongated member includes a first channel extending along a length of said first rail and wherein said first elongated flexible member is substantially positioned within said first channel of said first rail.

6. The lifting device of claim 5, wherein said second elongated member includes a second channel extending along a length of said second rail and wherein said second elongated flexible member is substantially positioned within said second channel of said second rail.

7. The lifting device of claim 6, wherein said first roller is positioned within said first channel and said second roller is positioned within said second channel.

8. The lifting device of claim 1, further comprising a stop member positioned to contact a lower surface of said frame at predetermined elevation of said frame.

9. The lifting device of claim 1, wherein said first elongated flexible member and said second elongated flexible member are selected from a group comprising: straps, chain, ropes, or cord.

10. A lifting device for furniture within a vehicle comprising:
a frame;
a winch disposed on said frame;
a first strap engaged with said winch to extend and retract, said first strap fixed to an interior of said vehicle to support at least a portion of said frame;
a second strap engaged with said winch to extend and retract, said first strap positioned along a portion of said frame and fixed to an interior of said vehicle to support at least a portion of said frame;
a first vertical channel positioned adjacent to said frame;
a second vertical channel positioned adjacent to said frame;
a first channel member disposed on said frame and at least partially positioned within said first vertical channel; and
a second channel member disposed on said frame and at least partially positioned within said second vertical channel;
wherein said first and second channel members are positioned sufficiently within said first and second vertical channel, so as to substantially restrict horizontal movement of said frame.

11. The lifting device of claim 10, further comprising:
a third strap engaged with said winch to extend and retract, said third strap fixed to an interior of said vehicle to support at least a portion of said frame;
a fourth strap engaged with said winch to extend and retract, said fourth strap positioned along a portion of said frame and fixed to an interior of said vehicle to support at least a portion of said frame;
a third vertical channel positioned adjacent to said frame;
a fourth vertical channel positioned adjacent to said frame;
a third channel member disposed on said frame and at least partially positioned within said third channel; and
a fourth channel member disposed on said frame and at least partially positioned within said fourth channel;
wherein said third channel member and said third vertical channel, and said fourth channel member and said fourth vertical channel are configured to restrict horizontal movement of said frame.

12. The lifting device of claim 10, wherein said first vertical channel and said second vertical channel are disposed within a wall of said vehicle.

13. The lifting device of claim 10, wherein said first channel member and said second channel member are selected from a group consisting of rollers, low friction pads, and bearings.

14. The lifting device of claim 10, further comprising a stop member positioned to contact a lower surface of said frame at a predetermined elevation.

15. The lifting device of claim 10, wherein said first strap is positioned to contact a first roller disposed on said frame and said second strap is positioned to contact a second roller disposed on said frame.

16. The lifting device of claim 10, wherein said first strap is removably coupled to a first mounting bracket above said first vertical channel and said second strap is removably coupled to a second mounting bracket above said second vertical channel.

17. The lifting device of claim 10, wherein said winch is rotated by a crank.

18. A method of adjusting a height of a furniture frame within a vehicle comprising:
providing a furniture frame and a winch disposed on said furniture frame;
actuating said winch to move a first strap at least partially supporting said furniture frame and a second strap at least partially supporting said furniture frame, causing said furniture frame to change elevation;
constraining horizontal movement of said furniture frame by minimizing a space between a first channel and said furniture frame and between a second channel said furniture frame.

19. The method of claim 18, further comprising at least partially concealing said second strap within said furniture frame.

20. The method of claim 18, further comprising contacting a lower surface of said furniture frame with a stop member.

21. The method of claim 18, further comprising at least partially concealing said first strap within a first vertical channel positioned adjacent to said furniture frame.

22. The method of claim 21, further comprising at least partially concealing said second strap within a second vertical channel positioned adjacent to said furniture frame.

23. A method of moving a frame in a vehicle comprising:
providing a support structure within said vehicle;
mounting said frame within said support structure;
attaching a hoist system to said frame;
concealing said hoist system from view substantially with said support structure;
actuating said hoist system to move said frame.

24. A method according to claim 23, further comprising substantially constraining any horizontal movement of said frame during actuating.

25. A lifting device within a vehicle comprising:
a frame;
a wheel rotatably disposed on a wall of said vehicle;
a first elongated flexible member having a first end coupled to said wheel and a second end coupled to a location on said vehicle above said frame;
a motor disposed on said wall of said vehicle and coupled to said wheel so as to cause rotation of said wheel;
a first rail fixed vertically adjacent to said frame and having a first channel extending along a length of said first rail;
a second rail fixed vertically adjacent to said frame and having a second channel extending along a length of said second rail;
a first roller disposed on said frame and positioned to roll within said first channel of said first rail; and
a second roller disposed on said frame and positioned to roll within said second channel of said second rail;
wherein said first and second roller are disposed in said first and second rail, respectively, so as to substantially constrain horizontal movement of said frame.

26. The lifting device of claim 26, wherein said motor and said wheel are fixed at a height above said first rail.

27. The lifting device of claim 26, further comprising:
a third rail fixed vertically adjacent to said frame and having a third channel extending along a length of said third rail;
a fourth rail fixed vertically adjacent to said frame and having a fourth channel extending along a length of said fourth rail;
a third roller disposed on said frame and positioned to roll within said third channel of said third rail; and
a fourth roller disposed on said frame and positioned to roll within said fourth channel of said fourth rail;
wherein said third roller and said third rail and said fourth roller and said fourth rail are configured to maintain a horizontal position of said frame.

28. The lifting device of claim 26, wherein said first elongated flexible member is positioned to contact said first roller.
